(19) United States
(12) Patent Application Publication
(10) Pub. No.: US 2026/0273881 A1
(43) Pub. Date: Sep. 17, 2026

(54) PICK-AND-PLACE SYSTEM, TIRE MANUFACTURING LINE AND METHOD FOR PICKING-UP A TIRE COMPONENT

(71) Applicant: VMI HOLLAND B.V., Epe (NL)

(72) Inventors: Marcel Alfred SMITS, Epe (NL); Teunis Johannes VERBRUGGEN, Epe (NL); Marco Johan PUT, Epe (NL)

(21) Appl. No.: 19/474,509

(22) PCT Filed: Mar. 12, 2024
(86) PCT No.: PCT/NL2024/050122

§ 371 Date: Oct. 10, 2025

(30) Foreign Application Priority Data
Apr. 14, 2023 (NL) 2034579

(51) Int. Cl. B29D 30/00; B25J 9/16; B25J 13/08; B25J 15/06; B29D 30/70

(52) U.S. Cl. CPC B29D 30/0016; B25J 9/1687; B25J 13/082; B25J 13/088; B25J 15/0616; B29D 30/70; B29D 2030/0038

(57) ABSTRACT

A pick-and-place system, a tire manufacturing line, and a method for picking-up a tire component are provided. The pick-and-place system comprises a support and a pick-and-place gripper for picking-up the tire component from the support. The pick-and-place gripper comprises a base, a gripper head and a drive unit for moving the gripper head relative to the base in a pick-and-place direction towards the support plane. The gripper head is configured for retaining the tire component in a gripper plane. The gripper head is tiltable between a first orientation and a second orientation. The gripper plane is parallel to the support plane in one orientation of the first orientation and the second orientation. The pick-and-place system further comprises a spacer for defining a minimum spacing distance between the gripper plane and the support plane when the gripper head is in said one orientation.

### BACKGROUND

The invention relates to a pick-and-place system, a tire manufacturing line and a method for picking-up a tire component.

EP 3 144 130 A1 discloses a gum strip applier for applying a gum strip over a butt joint between two ply strips at a butt splicer. The gum strip applier comprises a gum strip conveyor and a transfer device for automatically removing the gum strips from the gum strip conveyor and placing the gum strip onto the butt splicer at the butt joint between the two ply strips. The transfer device comprises a vacuum head that is resiliently mounted to provide a force against the gum strip upon the gum strip being placed at the butt joint. In particular, biasing components, such as compression springs, may be provided to apply a desired application force against the gum strip.

### SUMMARY OF THE INVENTION

A disadvantage of the known gum strip applier is that the butt splicer and the gum strip conveyor may not be aligned properly in the vertical direction. When the height of the vacuum head is calibrated relative to the butt splicer, the vacuum head may be positioned too low or too high relative to the gum strip conveyor. When the vacuum head is positioned too low, the forces exerted onto the gum strip may cause said gum strip to get stuck on the gum strip conveyor, making it difficult to reliably pick-up the gum strip. Moreover, the forces may cause damage to said gum strip. When the vacuum head is positioned too high, the vacuum head may also fail to reliably pick up the gum strip due to lack of suction.

It is an object of the present invention to provide a pick-and-place system, a tire manufacturing line and a method for picking-up a tire component, wherein the pick-up of the tire component can be improved.

According to a first aspect, the invention provides a pick-and-place system for picking-up a first tire component, wherein the pick-and-place system comprises a support for supporting the first tire component in a support plane, and a pick-and-place gripper for picking-up the first tire component from the support, wherein the pick-and-place gripper comprises a base, a first gripper head and a drive unit for moving the first gripper head relative to the base in a pick-and-place direction towards the support plane, wherein the first gripper head is configured for retaining the first tire component in a gripper plane, wherein the first gripper head is tiltable about a tilt axis perpendicular to the pick-and-place direction between a first orientation and a second orientation, different from the first orientation, wherein the gripper plane is parallel to the support plane in one orientation of the first orientation and the second orientation, wherein the pick-and-place system further comprises a first spacer for defining a minimum spacing distance between the gripper plane and the support plane when the first gripper head is in said one orientation.

The first gripper head can align itself in an automatic and/or compliant manner relative to the support such that the gripper plane extends parallel or substantially parallel to the support plane, to enable picking-up of the first tire component as it is being supported on the support in said support plane. By maintaining the first gripper head at the minimum spacing distance in accordance with the present invention, it may be prevented that the first gripper head is positioned too low or too high relative to the first tire component to be picked up. In particular, the minimum spacing distance may be chosen so as to be optimal for picking-up the first tire component without applying excessive pressure onto said first tire component. In fact, the minimum spacing distance may be chosen to be marginally larger than the thickness of the first tire component, such that the first gripper head does not contact the first tire component initially, while being sufficiently close to pick-up the first tire component through suction.

In one embodiment the minimum spacing distance is at least half a millimeter, and preferably at least one millimeter. Such a spacing distance can be sufficient to reliably pick-up a first tire component of an equal or slightly smaller thickness, for example a gum strip, without excessively pressing the first tire component against the support and/or without damaging said first tire component.

In a further embodiment the first gripper head is positionable in a pick-up position in the pick-and-place direction above the support plane for picking-up the first tire component from the support, wherein the first spacer is located in the pick-and-place direction between the first gripper head and the support when the first gripper head is in the pick-up position. Hence, the first spacer can physically separate the first gripper head from the support at a position in between said first gripper head and the support. Note that the first spacer may be held relative to and/or connected to the support. Alternatively, the first spacer may be connected to and/or projecting from the first gripper head.

Preferably, the first spacer comprises a bridge extending in a bridge direction perpendicular to the pick-and-place direction between the first gripper head and the support when the first gripper head is in the pick-up position. By placing the bridge in a way that it extends in the bridge direction across the support, allows for supporting said bridge relative to the support at a side of the support. Hence, the support itself can be kept clear of components relating to the bridge which could potentially interfere with the supporting and/or conveying of the first tire component on said support.

More preferably, the first spacer comprises a first leg for positioning the bridge relative to the support, wherein the bridge projects from the first leg in the bridge direction over the support. The bridge may thus extend over the support in said bridge direction without interfering with the first tire component on said support.

Most preferably, the first spacer comprises a second leg for positioning the bridge relative to the support, wherein the first leg and the second leg are positioned on opposite sides of the support in the bridge direction. By supporting the bridge on both sides of the support, the bridge can keep the first gripper head at the minimum spacing distance in a more stable and/or rigid manner.

In another embodiment the first spacer forms a resting surface for resting the first gripper head on said first spacer in the pick-and-place direction. The first gripper head can thus be supported in physical abutment on the first spacer.

Preferably, the resting surface is arranged at a set spacer height above the support plane. The spacer height may be chosen such that the gripper plane is kept at the minimum spacing distance. Note that the spacer height may be different from the minimum spacing distance, for example to create a clearance between the first spacer and the support without raising the minimum spacing distance.

More preferably, the first spacer comprises a spacer body and a height adjuster that defines the resting surface relative to the spacer body and sets the spacer height. The height adjuster may be adjustable, for example like a screw adjustment, or removable, detachable and/or exchangeable for an alternative height adjuster with a different height, to set the desired spacer height. By changing the spacer height, the minimum spacing distance can be adjusted, for example when a different tire component is to be picked-up having a different thickness.

In another embodiment the first spacer comprises a spacer body that extends clear of the support plane at a gap height to define an infeed gap for the first tire component between the support plane and the spacer body. The infeed gap allows for the first tire component to be passed underneath said spacer body without contacting the spacer body.

In another embodiment the first spacer defines the minimum spacing distance at a first spacing position, wherein the pick-and-place system further comprises a second spacer for defining the minimum spacing distance at a second spacing position spaced apart from the first spacing position in a longitudinal direction parallel to the support plane and perpendicular to the tilt axis. By providing the two spacers in the two spacing positions, the first gripper head can be supported in a more reliable and/or stable manner. In particular, the first gripper can be compliantly urged or forced into said one orientation in which the gripper plane is parallel to the support plane. Moreover, a pick-up area in the longitudinal direction between the two spacing positions can be kept free of the spacers, thereby allowing for picking-up of the first tire component in said pick-up area, without the spacers interfering with said picking-up.

Preferably, the pick-and-place system comprises a conveyor that forms the support surface and that is configured for conveying the first tire component in a feeding direction parallel to the longitudinal direction, wherein the second spacer is located downstream of the first spacer in the feeding direction. Hence, the spacers can be spaced apart from each other in the feeding direction. Moreover, when combining this embodiment with the previously discussed embodiment that introduced the infeed gap at the first spacer, it will be appreciated that the first tire component can be fed through the infeed gap underneath the first spacer in said feeding direction into the pick-up area between both spacers.

In another embodiment the first gripper head comprises a gripper body that forms a first abutment surface for resting on the first spacer. The first abutment surface can be specially dedicated and/or adapted to rest on the first spacer in a reliable and/or stable manner. Moreover, said first abutment surface may be kept free of components of the first gripper head that are responsible for picking-up of the first tire component such that placement of the first gripper head on the first spacer does not interfere with the ability of said first gripper head to pick-up the first tire component.

Preferably, the gripper body further forms a retaining surface for retaining the first tire component to the gripper body in the gripper plane, wherein first abutment surface is recessed with respect to the retaining surface in a recess direction parallel to the pick-and-place direction, away from the support plane. Hence, the first gripper head may be supported on the first spacer at a height above the support plane that exceeds the minimum spacing distance, while maintaining the retaining surface at the gripper plane. This allows for the first spacer to be designed as previously discussed, with a spacer height that is higher than the minimum spacing distance, for example for providing the aforementioned infeed gap.

In another embodiment the pick-and-place system further comprises a first suspension member and a second suspension member for suspending the first gripper head relative to the base at a first suspension height and a second suspension height, respectively, wherein the first suspension member is configured for varying the first suspension height relative to the second suspension height. Hence, the gripper head may be tilted about the tilt axis by varying at least the first suspension height to be different from the second suspension height.

Preferably, the second suspension member is configured for varying the second suspension height relative to the first suspension height. Hence, both suspension height may be varied to allow the first gripper head to assume said one orientation in which the gripper plane is parallel to the support plane.

More preferably, the drive unit comprises a first pick-and-place drive and a second pick-and-place drive which are operationally connected to the first suspension member and the second suspension member for controlled displacement of said suspension members in the pick-and-place direction. The pick-and-place drives may for example be used to displace the suspension members in the pick-and-place direction away from the support when the first tire component is retained to the first gripper head to pick-up said first tire component from the support. Additionally or alternatively, the pick-and-place drives may be used to actively tilt the first gripper head about the tilt axis, for example to already position the first gripper head in said one orientation prior to the first gripper head contacting the first spacer.

Most preferably, the first gripper head is configured to be displaceable parallel to the pick-and-place direction independently of the first pick-and-place drive and the second pick-and-place drive, wherein the pick-and-place system is further provided with a displacement sensor at each suspension member for distinguishing between controlled displacement and independent displacement of the respective suspension member. The displacement sensors may be able to detect when the first gripper head is displaced and/or lifted in an uncontrolled manner, for example as a result of irregularities in the first tire component. The process may then be interrupted and a human operator may be alerted to investigate.

In another embodiment the drive unit is further configured for moving the pick-and-place gripper in a first drive direction orthogonal to the pick-and-place direction and a second drive direction orthogonal to the first drive direction and the pick-and-place direction. The drive unit may therefore operate like an XYZ-drive system, with the orthogonal XYZ-directions corresponding to the two drive directions and the pick-and-place direction. The tilt of the first gripper head about the tilt axis provides a fourth degree of freedom.

In another embodiment the pick-and-place gripper further comprises a second gripper head for retaining a second tire component, wherein the second gripper head is tiltable in the same way as the first gripper head, wherein the first spacer is configured for defining the minimum spacing distance also at the second gripper head. Hence, the same first spacer may be used to keep both gripper heads at the minimum spacing distance.

Preferably, the first gripper head and the second gripper head are arranged side-by-side in a lateral direction, wherein the first spacer extends in said lateral direction over a spacer width that spans both the first gripper head and the second gripper head. In other words, the first spacer is sufficiently wide to support both gripper heads simultaneously. Therefore, no dedicated spacers are requires for the second gripper head.

Additionally or alternatively, the first gripper head and the second gripper head are configured for picking-up strip-like tire components, in particular gum strips. By providing to gripper heads at the pick-and-place gripper, two gum strips can be picked up and transferred to a breaker station and/or a gum strip folding station in a single transfer action. The two gum strips may be picked-up simultaneously or one after the other. Once the gripper heads of the pick-and-place gripper retain both gum strips, they can be transferred simultaneously.

In another embodiment, that may also be applied to a gripper head independently of the pick-and-place system, the first gripper head comprises a gripper body that forms a retaining surface for retaining the first tire component to the gripper body in the gripper plane, wherein the first gripper head further comprises a plurality of retaining openings for retaining the first tire component to the gripper body through suction and a verification opening for verifying that the first tire component is properly retained to the plurality of retaining openings, wherein the gripper body forms a vacuum chamber that is arranged in air communication with the plurality of retaining openings and a verification chamber that is arranged in air communication with the verification opening, wherein the verification chamber is further arranged in air communication with the vacuum chamber through a connection channel, wherein the pick-and-place system further comprises a vacuum sensor for measuring pressure in the verification chamber.

When the first tire component is picked-up by the plurality of retaining openings through suction, some retaining openings of the plurality of retaining openings may not be covered or fully covered by the first tire component, causing a certain amount of leak. When the number of retaining openings of the plurality of retaining openings is large, e.g. in excess of twenty, the pressure loss will be minimal and it will be difficult to notice such a leak. To improve the accuracy of the detection of leaks, the pressure in the vacuum chamber is compared to the pressure in the verification chamber. If the verification opening is covered, the pressures should be equal. If the verification opening is not covered, ambient pressure will enter the verification chamber, causing a pressure difference between the verification chamber and the vacuum chamber. The vacuum sensor can measure the pressure directly in the verification chamber and can therefore accurately determine if such a pressure difference is significant and/or indicative of a leak.

Preferably, the verification opening, in cross section, has a first surface area, wherein the connection channel, in cross section, has a second surface area equal to or smaller than the first surface area. By restricting air flow to the verification chamber from the ambient air and the vacuum chamber to the same cross section, the pressure as measured in the verification chamber should more or less approximate the average between the ambient pressure and the pressure in the vacuum chamber. Hence, there will be a significant difference in pressure between the vacuum chamber and the verification chamber, which difference can be effectively used to determine if a leak has occurred during the picking-up of the first tire component.

According to a second aspect, the invention provides a tire manufacturing line comprising the pick-and-place system according to any one of the embodiments of the first aspect of the invention, wherein the tire manufacturing line further comprises a gum strip supply station, a breaker supply station and/or a gum strip folding station, wherein the pick-and-place system is configured for transferring one or more gum strips from the gum strip supply station to the breaker supply station and/or the gum strip folding station.

The tire manufacturing line according to the second aspect comprises the pick-and-place system according to the first aspect of the invention and therefore has the same technical advantages, which will not be repeated hereafter.

In one embodiment thereof, that may also be applied to a cutting device independently of the aforementioned tire manufacturing line, the gum strip supply station comprises a cutting device for cutting a continuous strip to length to form the gum strips, wherein the cutting device comprises a cutting table for supporting the continuous strip in a cutting plane and a holder for holding the cutting table, wherein the cutting table is rotatable about one or more rotation axes parallel to the cutting plane. Hence, the orientation of the cutting table can be made to be compliant with a counter surface, such as an anvil, positioned directly opposite to said cutting table, even if said counter surface is positioned at a slight angle to the initial orientation of the cutting plane.

Preferably, the one or more rotation axes comprises first rotation axis and a second rotation axis orthogonal to the first rotation axis. Hence, the cutting table has at least two degrees of freedom to comply with the orientation of the counter surface.

Additionally or alternatively, at least one rotation axis of the one or more rotation axes coincides with the cutting plane. In this way, the cutting table can be kept at the same height for at least one position along said one rotation axis.

In a further embodiment the first gripper head comprises an anvil that cooperates with the cutting table to hold the continuous strip for cutting, wherein the cutting table is freely rotatable about the one or more rotation axes to adapt its orientation to the anvil. As mentioned previously, the cutting table can thus passively or compliantly follow and/or adapt its orientation to that of the anvil.

According to a third aspect, the invention provides a method for picking-up a first tire component using the pick-and-place system according to any one of the embodiments of the first aspect of the invention, wherein the method comprises the steps of:
supporting the first tire component in the support plane;
moving the first gripper head relative to the base in the pick-and-place direction towards the support plane;
causing a tilt of the first gripper head about the tilt axis into said one orientation in which the gripper plane is parallel to the support plane; and
using the first spacer to maintain the minimum spacing distance between the gripper plane and the support plane when the first gripper head is in said one orientation.

The method according to the third aspect of the invention relates to the practical implementation of the pick-and-place system according to the first aspect of the invention and therefore has the same technical advantages, which will not be repeated hereafter.

Preferably, the minimum spacing distance is chosen such that the first gripper head does not contact the first tire component initially when the first gripper head is at the minimum spacing distance in said one orientation.

In one embodiment of the method the first gripper head is tilted about the tilt axis as a result of contact of said first gripper head with the first spacer.

In an alternative embodiment of the method, the first gripper head is tilted about the tilt axis by the drive unit to a previously configured tilt angle corresponding to said one orientation prior to contact between the first gripper head and the first spacer.

The various aspects and features described and shown in the specification can be applied, individually, wherever possible. These individual aspects, in particular the aspects and features described in the attached dependent claims, can be made subject of divisional patent applications.

### BRIEF DESCRIPTION OF THE DRAWINGS

The invention will be elucidated on the basis of an exemplary embodiment shown in the attached schematic drawings, in which:

FIG. 1 shows an isometric view of a tire manufacturing line according to a first exemplary embodiment of the invention, comprising a pick-and-place gripper with two gripper heads, a gum strip supply station, a gum strip folding station and a breaker supply station;

FIGS. 2, 3 and 4 shows side views of the pick-and-place gripper and the gum strip supply station according to FIG. 1, simplified by only showing one gripper head of the two gripper heads, during steps of a method for picking-up a first tire component;

FIG. 5 shows a front view of the simplified pick-and-place gripper and the gum strip supply station of FIG. 2;

FIG. 6 shows a front view of the gum strip supply station of FIG. 5 during step of exchanging a height adjuster;

FIG. 7 shows a front view of an alternative gum strip supply station according to a second exemplary embodiment of the invention;

FIGS. 8 and 9 show a side view and a front view, respectively, of the pick-and-place gripper and the gum strip supply station according to FIG. 1, including both gripper heads;

FIGS. 10 and 11 show side views of a suspension member for suspending one of the gripper heads of FIG. 1 during the steps of adjusting a suspension height of the respective gripper head;

FIGS. 12 and 13 show side views of a vacuum zone of one of the gripper heads of FIG. 1 during the steps of retaining the first tire component through suction;

FIG. 14 shows a top view of a cutting device of the gum strip supply station having a plurality of cutting tables;

FIGS. 15 and 16 show side views of one of the cutting tables of FIG. 14;

FIGS. 17 and 18 show front views of one of the cutting tables of FIG. 14; and

FIG. 19 shows an isometric view of a drive unit of the pick-and-place gripper according to FIG. 1.

### DETAILED DESCRIPTION OF THE INVENTION

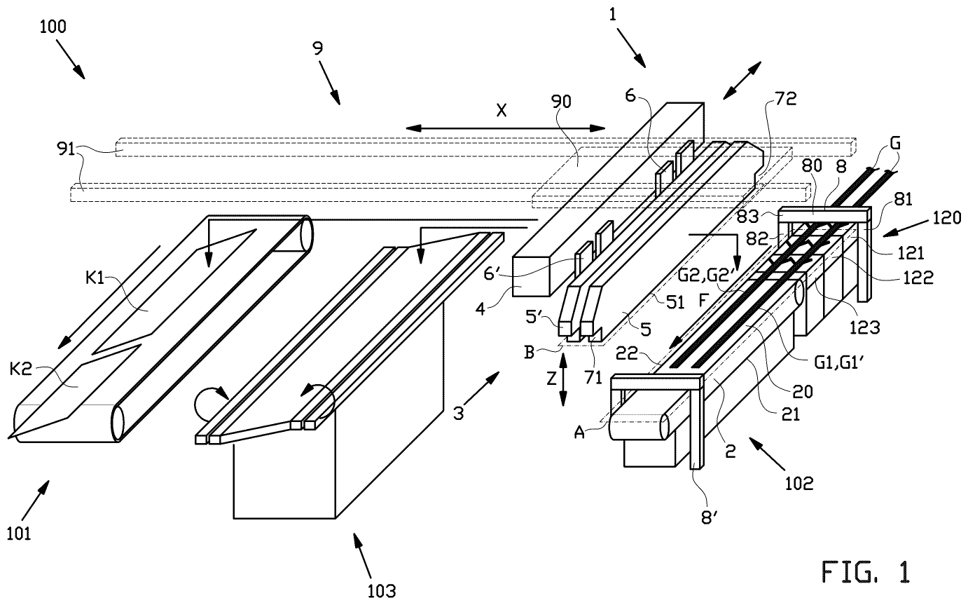

FIG. 1 shows a tire manufacturing line 100 according to an exemplary embodiment of the invention for manufacturing a green or unvulcanized tire, or tire components G1, G2 thereof. In particular, the tire manufacturing line 100 as shown is configured for cutting to length and applying gum strips G1′, G2′ at or around longitudinal edges of breaker plies K1, K2. It will however be apparent to one skilled in the art that the invention may be applied to other tire components G1, G2 as well, specifically to strip-like tire components, such as side walls, apex filler strips, reinforcement strips and/or chafers.

As shown in FIG. 1, the tire manufacturing line 100 comprises a breaker supply station 101 for supplying the breaker plies K1, K2, a gum strip supply station 102 for supplying the gum strips G1′, G2′, and optionally a gum strip folding station 103 for folding the gum strips G1′, G2′ around the edges of the breaker plies K1, K2. The tire manufacturing line 100 further comprises a pick-and-place system 1 for picking-up the gum strips G1′, G2′ from the gum strip supply station 102 and for transferring and/or placing said picked-up gum strips G1′, G2′ to the gum strip folding station 103 or directly to the breaker supply station 101.

The gum strips G1′, G2′ may be applied directly to the breaker plies K1, K2 at the breaker supply station 101 when said gum strips G1′, G2′ are applied to one side of the breaker plies K1, K2 only. When the gum strips G1′, G2′ are to be folded around the edges, then the gum strips G1′, G2′ are first provided on the gum strip folding station 103, after which one of the breaker plies K1, K2 is transferred from the breaker supply station 101 to the gum strip folding station 103 and placed on the gum strips G1′, G2′. The gum strip folding station 103 comprises a folding mechanism, as for example disclosed in WO 2018/139917 A1, to fold the gum strips G1′, G2′ around the edges of said one breaker ply K1, K2. Alternatively, the gum strips G1′, G2′ may be folded around the edges of the breaker plies K1, K2 on the fly or while in motion, with a set of progressively tilted folding rollers arranged along the conveying path of said breaker plies K1, K2 in the breaker supply station 101.

As further shown in FIG. 1, the gum strip supply station 102 comprises a cutting device 120 having one or more cutting tables 121-123, in this example three cutting tables 121-123, for receiving a continuous strip G from an upstream station, for example an extruder (not shown).

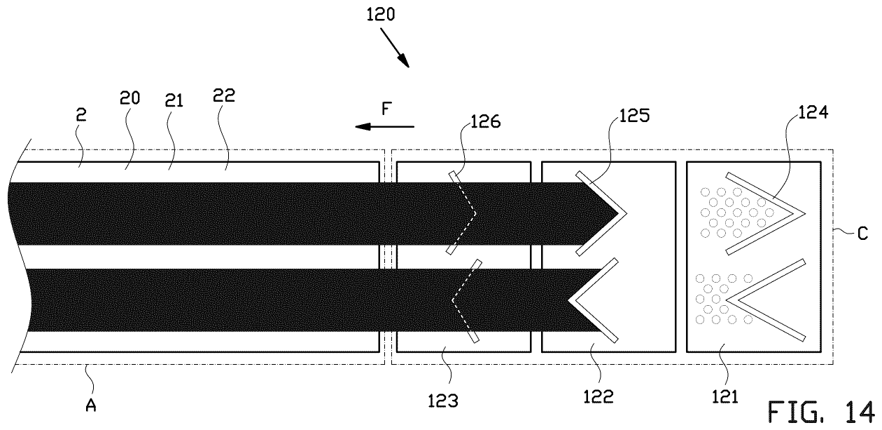

As best seen in FIG. 14, each cutting table 121-123 is provided with a cutting slot 124-126 through which a knife can be passed to cut the continuous strip G to length into individual gum strips G1′, G2′. In this example, the cutting slots 124-126 are V-shaped. Each cutting slot 124-126 has a different included angle of the V-shape, allowing for cutting the continuous strip G at said different included angles. When switching to a different cutting table 121-123 for cutting the continuous strip G, the leading end of the continuous strip G that was last cut is cut off by the newly selected cutting table 121-123 and discarded as waste. Then, the predetermined length for the gum strip G1′, G2′ to be cut at the newly selected cutting table 121-123 is fed beyond the cutting slot 124-126 of said newly selected cutting table 121-123. Subsequently, the continuous strip G1′, G2′ may be cut to length.

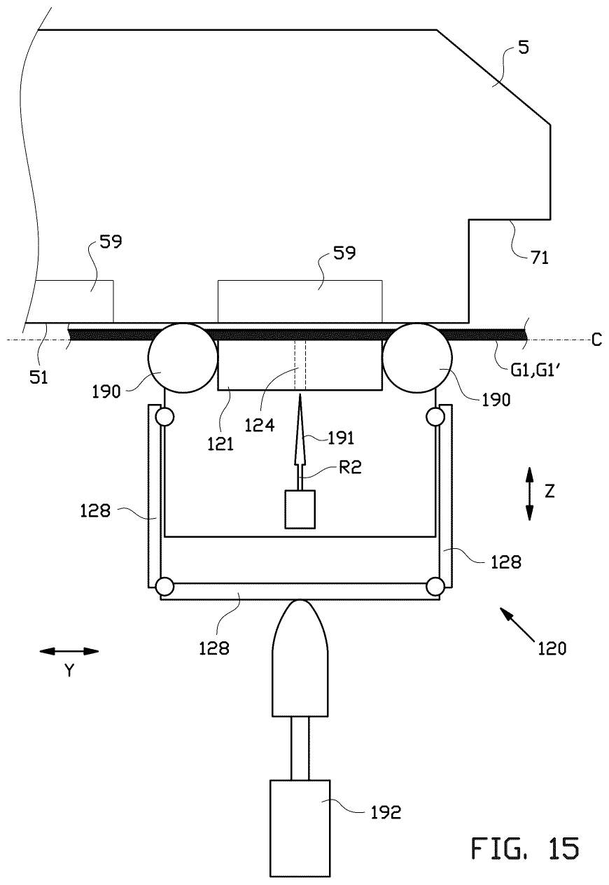

FIGS. 15-18 show the first cutting table 121 of the one or more cutting tables 121-123 in more detail. It will be apparent to one skilled in the art that the features described in relation to the first cutting table 121 apply, mutatis mutandis, to the other cutting tables 122, 123.

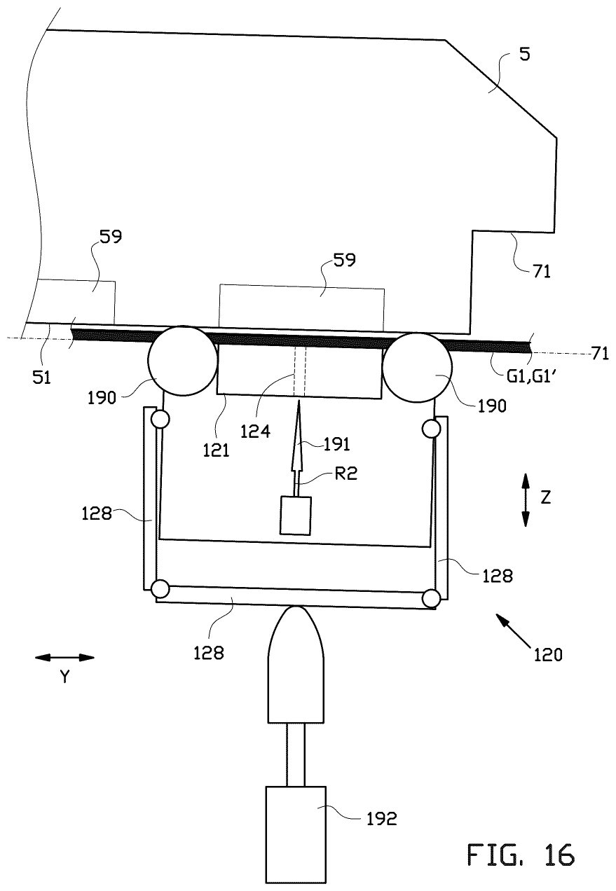

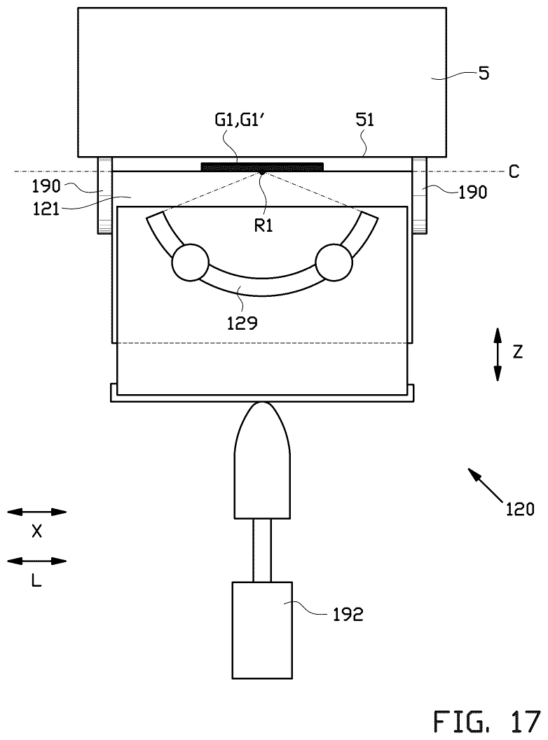

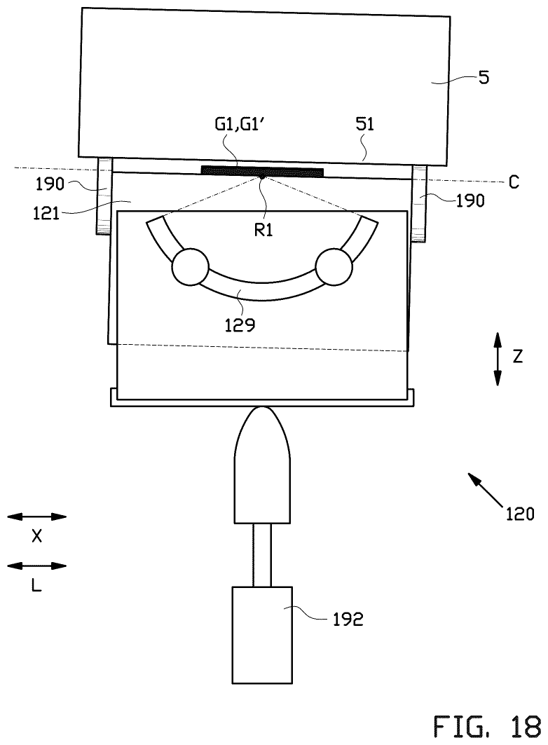

When comparing FIGS. 15-18, it is shown that the first cutting table 121 about a first rotation axis R1 and a second rotation axis R2, orthogonal to the first rotation axis R1, and both parallel to the cutting plane C. In particular, the cutting device 120 comprises a holder 127 for holding the first cutting table 121 in a certain orientation. Said holder 127 comprises one or more mechanisms to provide the aforementioned degrees of freedom to the first cutting table 121. In this exemplary embodiment, as shown in FIGS. 15 and 16, the holder 127 comprises one or more linkages 128 to allow for rotation of the first cutting table 121 about the first rotation axis R1. Furthermore, as shown in FIGS. 17 and 18, the holder 127 comprises an arcuate slot 129 and pins movable through said slot to allow for rotation of the first cutting table 121 about the second rotation axis R2. Note that the arcuate slot 129 in FIGS. 17 and 18 extends concentric to a virtual axis, conveniently extending in or coinciding with the cutting plane C.

It will be appreciated that many alternative mechanisms may yield the same effect, which would yet be encompassed by the scope of the present invention.

The cutting device 120 further comprises a cutting table pusher 192 for pushing the first cutting table 121 upwards towards the counter surface and/or the anvil 59 at the first gripper head 5, such that the first cutting table 121 can automatically adapt to the orientation of said counter surface and/or anvil 59.

As shown in FIG. 1, the pick-and-place system 1 comprises a support 2 for supporting the gum strips G1′, G2′ in a support plane A. In this example, the support 2 comprises a conveyor 21 for conveying and/or feeding the gum strips G1′, G2′ in a feeding direction F in or along said support plane A. Specifically, the conveyor 21 comprises an endless conveyor belt 22 that, in its upper run, defines a support surface 20 for supporting the gum strips G1′, G2′ in said support plane A.

Note that the conveyor 21 may also be considered a part of the gum strip supply station 102.

The pick-and-place system 1 further comprises a pick-and-place gripper 3 for picking-up the gum strips G1′, G2′ from the support 2. Said pick-and-place gripper 3 comprises a base 4, a first gripper head 5, a second gripper head 5′, and a drive unit 9 for moving the gripper heads 5, 5′ relative to the base 4 in a pick-and-place direction Z towards the support plane A.

In this exemplary embodiment, the drive unit 9 provides at least three degrees of freedom to the gripper heads 5, 5′, in particular in a first drive direction X, a second drive direction Y orthogonal to the first drive direction X and the pick-and-place direction Z orthogonal to both the first drive direction X and the second drive direction Y. The first drive direction X may alternatively be referred to as a lateral direction L or a bridge direction. The second drive direction Y may alternative be referred to as the feeding direction F or a longitudinal direction.

In this example, the pick-and-place direction Z is vertical or substantially vertical. Consequently, the first drive direction X and the second drive direction Y are horizontal or substantially horizontal.

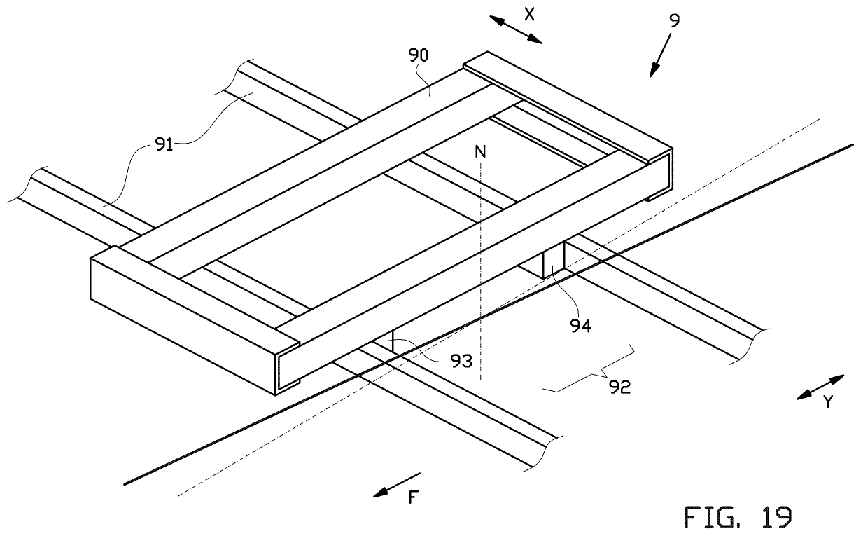

FIG. 19 shows a part of the drive unit 9 in more detail. The drive unit 9 comprises a drive frame 90 for carrying the pick-and-place gripper 3 of FIG. 1. The drive frame 90 is laterally movable in the first drive direction X or the lateral direction L over or along a set of drive rails 91. The drive unit 9 comprises a lateral drive 92 for driving said lateral movement. In this example, the lateral drive 92 is formed by two individually controllable lateral motors 93, 94 that allow for minor corrections and/or adjustments of the orientation of the pick-and-place gripper 3 about a vertical correction axis N, for example to align said pick-and-place gripper 3 with the gum strip feeding station 102 in FIG. 1.

As mentioned earlier, the pick-and-place gripper 3 has two gripper heads 5, 5′ and can therefore be considered as a dual gripper. It will however be appreciated that the invention may also be applied to a pick-and-place gripper 3 having a single gripper head, for example only the first gripper head 5.

In the dual gripper configuration as shown in FIG. 1, the first gripper head 5 and the second gripper head 5′ are configured for picking-up the first gum strip G1′ and the second gum strip G2′, respectively, either simultaneously or one after the other. The gripper heads 5, 5′ are located side-by-side in the first drive direction X or the lateral direction L. In this example, both gripper heads 5, 5′ are suspended from and/or carried by the same base 4.

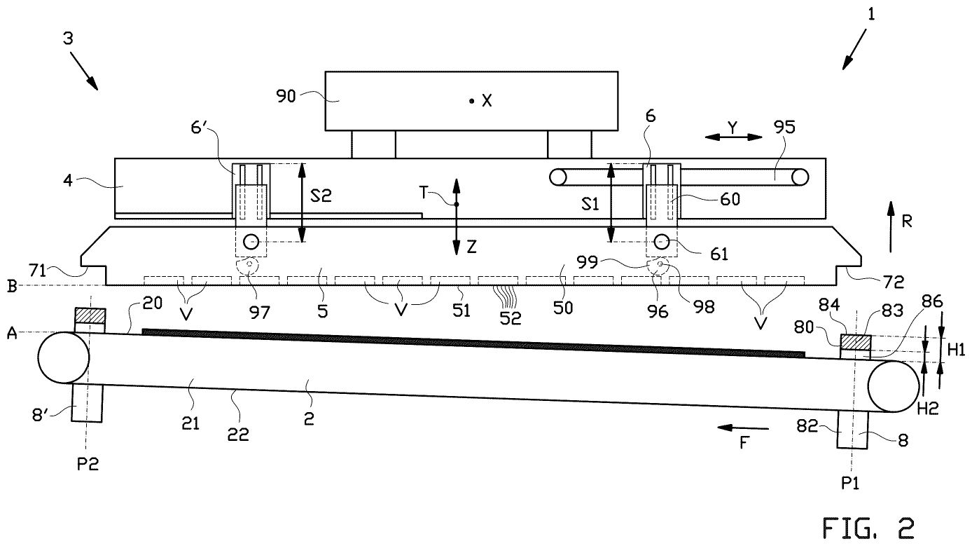

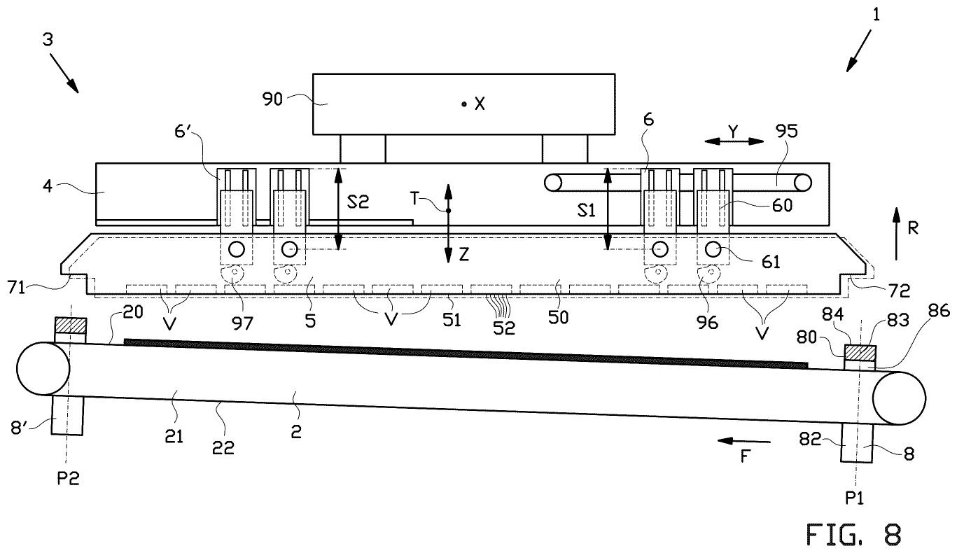

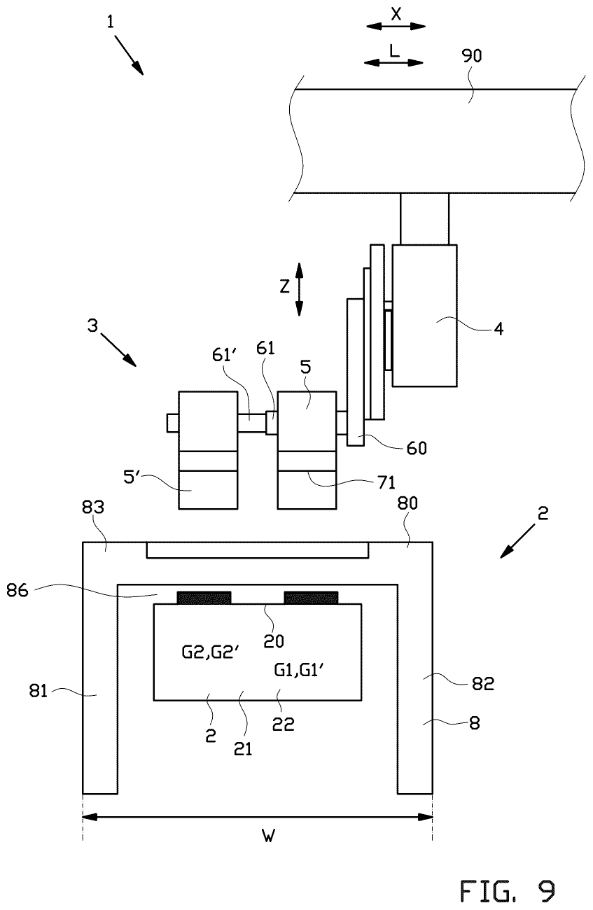

In FIGS. 2-5, the pick-and-place gripper 3 is shown in a simplified form with the first gripper head 5 only. Note that in FIGS. 8 and 9, the pick-and-place gripper 3 is shown with both the first gripper head 5 and the second gripper head 5′. The second gripper head 5′ is shown in dashed lines and is shown slightly offset with respect to the first gripper head 5. In reality however, the second gripper head 5′ may be located directly and/or fully behind the first gripper head 5, and may thus be completely hidden from view.

It will be understood that the first gripper head 5 and the second gripper head 5′ have similar features and/or functionality in the way that they pick-up their respective gum strips G1′, G2′. Hence, the operation of the first gripper head 5 is explained hereafter with reference to the first gripper head 5 only. However, the following description applies, mutatis mutandis, also to the second gripper head 5′.

As best seen in FIG. 2, the first gripper head 5 comprises a gripper body 50 that forms or defines a retaining surface 51 for retaining the first gum strip G1′ to the gripper body 50 in a gripper plane B. In this example, the gripper body 50 is elongated and/or extends along a length that is sufficient for picking-up the entire length of the first gum strip G1′. In particular, the first gripper body 50 may be shaped like a beam. The first gripper head 5 further comprises a plurality of retaining openings 52 debouching from the gripper body 50 in or at the gripper plane B for retaining the first tire component G1 to the gripper body 50 through suction. The retaining openings 52 are grouped into a plurality of independently controllable vacuum zones V.

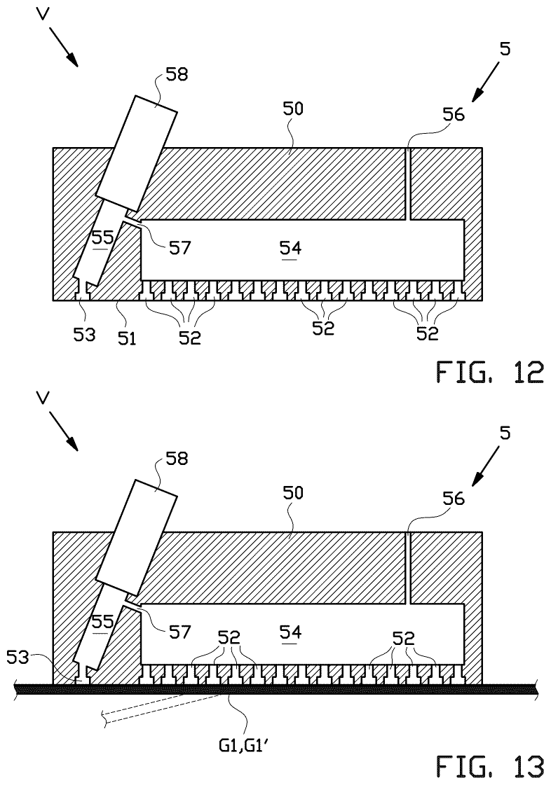

FIGS. 12 and 13 show one of the vacuum zones V in more detail. The first gripper head 5 is provided with a vacuum chamber 54 in each vacuum zone V that is arranged in air communication with the plurality of retaining openings 52 of the respective vacuum zone V. The first gripper head 5 is further provided with a vacuum channel 56 for connecting the vacuum chamber 54 to a source of (partial) vacuum.

The first gripper head 5 is further provided with a verification opening 53 debouching from the gripper body 50 in or at the gripper plane B. The verification opening 53, in cross section, has a first surface area. The verification opening 53 is strategically positioned relative to the retaining openings 52 to check the presence, absence and/or correctness of the retaining of the first gum strip G1′ at the first gripper head 5 at the position of said verification opening 53. The verification opening 53 may for example be located just downstream of the plurality of retaining openings 52 of the respective vacuum zone V in the feeding direction F.

The first gripper head 5 further comprises a verification chamber 55 that is arranged in air communication with the verification opening 53. The verification chamber 55 is further arranged in air communication with the vacuum chamber 54 through a connection channel 57. The connection channel 57, in cross section, has a second surface area that is equal to or smaller than the first surface area of the verification opening 53.

The pick-and-place system 1 further comprises a vacuum sensor 58 that is operationally connected to or provided in or at the first gripper head 5 for measuring pressure in the verification chamber 55. By restricting air flow to the verification chamber 55 from the ambient air and the vacuum chamber 54 to the same cross section, the pressure as measured in the verification chamber 53 should more or less approximate the average between the ambient pressure and the pressure in the vacuum chamber 54. Hence, when the first gum strip G1′ does not fully cover all of the retaining opening 52 in the respective vacuum zone V and/or the verification opening 53, as shown schematically with dashed lines in FIG. 13, there will be a significant difference in pressure between the vacuum chamber 54 and the verification chamber 55, which difference can be effectively used to determine if a leak has occurred during the picking-up of the first gum strip G1′.

As shown in FIG. 15, the first gripper head 5 is further provided with one or more anvils 59 which are located directly opposite to the one or more cutting tables 121-123 of the cutting device 120 in FIG. 1 when the first gripper head 5 is in a pick-up position above the gum strip supply station 102, to cooperate with the knives 128 of the respective cutting tables 121-123 to cut the continuous strip G to length.

As shown in FIGS. 15-18, the first cutting table 121 may optionally be provided with one or more guide wheels 190 that may allow relative movement between the pick-and-place gripper 3 and the first cutting table 121 in the longitudinal direction, as well as keep the cutting plane C slightly spaced apart from the gripper plane B to prevent excessive forces on the first gum strip G1′.

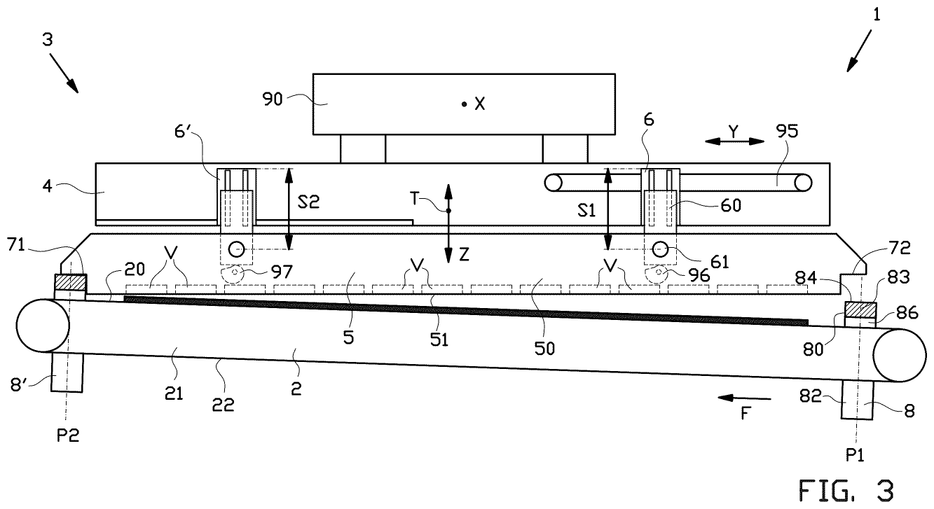

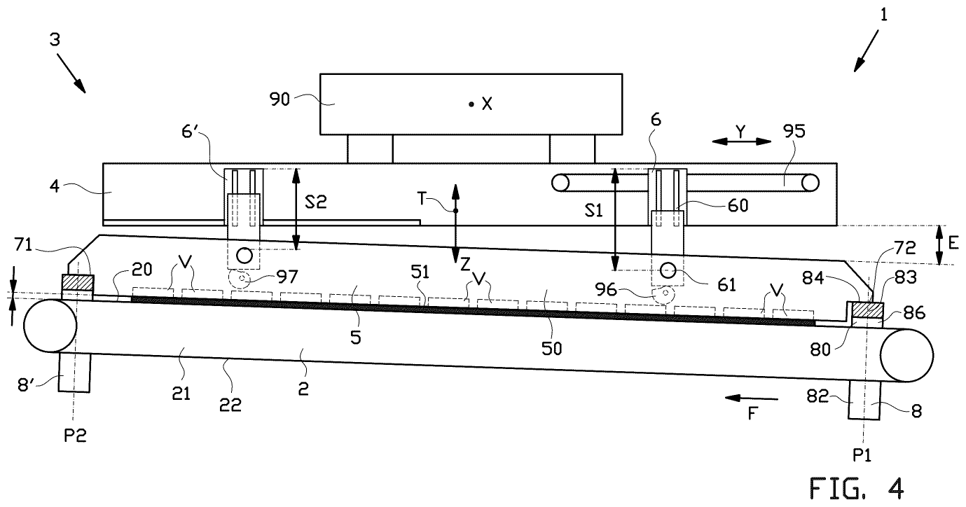

As shown in FIGS. 2-4, the first gripper head 5 and the support 2 may not be aligned properly. In particular, the support plane A defined by the support 2 may be at a slight angle to the gripper plane B of the first gripper head 5. To compensate for the misalignment, the first gripper head 5 is tiltable about a tilt axis T perpendicular to the pick-and-place direction Z between a first orientation (in this example a neutral or horizontal orientation), as shown in FIGS. 2 and 3, and a second orientation (in this example a tilted orientation), different from the first orientation, as shown in FIG. 4. In the first orientation, the gripper plane B extends at an angle to the support plane A, while in the second orientation, the gripper plane B is parallel or substantially parallel to the support plane A.

To allow for the tilt of the first gripper head 5, the pick-and-place system 1 is provided with a first suspension member 6 and a second suspension member 6′ for suspending the first gripper head 5 relative to the base 4 at a first suspension height S1 and a second suspension height S2, respectively. Similar suspension members may be provided for the second gripper head 5′, as shown in FIG. 8 without reference numerals. The drive unit 9 comprises a longitudinal drive 95, for example a timing belt, to move at least one of the suspension members 6, 6′ in the second drive direction Y or the longitudinal direction. The other of the suspension members 6′ may be slidably mounted on a guide rail to move in the same direction. At least one of the suspension members 6, 6′, and in this example both, are configured for varying their respective suspension heights S1, S2.

As further shown in FIGS. 2-4, the drive unit 9 comprises a first pick-and-place drive 96 and a second pick-and-place drive 97 which are operationally connected to the first suspension member 6 and the second suspension member 6′ for controlled displacement of said suspension members 6, 6′, and thus of the first gripper head 5, in the pick-and-place direction Z. In this example, the pick-and-place drives 96, 97 comprise drive cams 98 having a cam lobe 99 that converts rotation of the drive cams 98 into an upward movement of the respective suspension members 6, 6′.

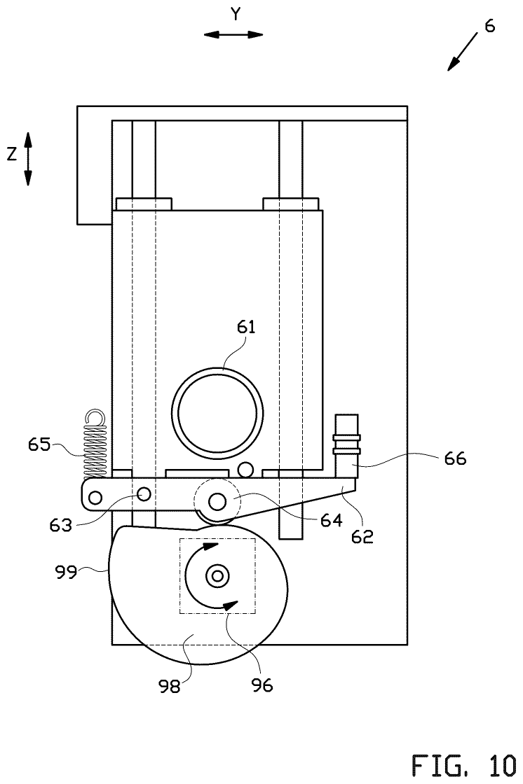

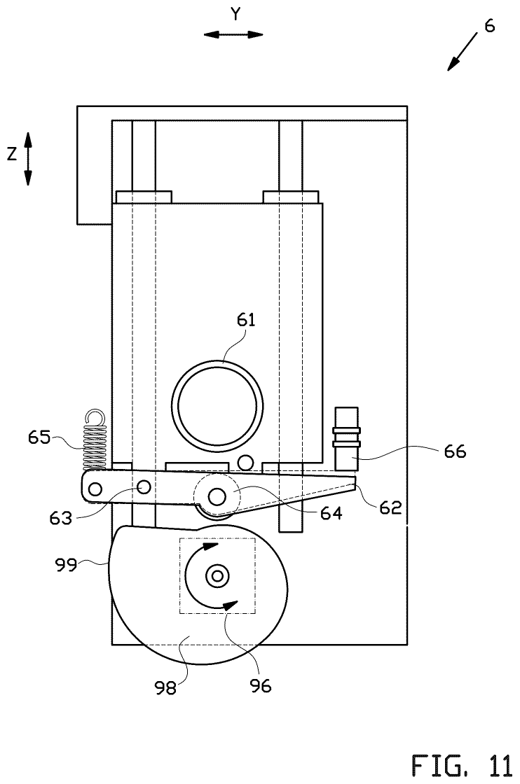

FIGS. 10 and 11 show the operation of the first pick-and-place drive 96 and the first suspension member 6 in more detail. It will be appreciated that the following description applies, mutatis mutandis, to the second suspension member 6′ and the second pick-and-place drive 97.

As shown in FIG. 10, the first suspension member 6 comprises a carriage 60 that is movable in the pick-and-place direction Z along a set of rails. The carriage 60 is provided with a first shaft 60 for carrying the first gripper head 5, as shown in FIG. 2. Continuing in FIG. 10, note that the first suspension member 6 is provided with a lever 62 that is rotatable about a hinge 63. The first suspension member 6 is further provided with a follower 64, in particular a cam roller, mounted to the lever 62 at one side of the hinge 63, to rest on the drive cam 98 of the first pick-and-place drive 96. The first suspension member 6 may optionally be provided with a biasing member 65, for example a spring, to bias the follower 64 into contact with the drive cam 98.

Note that, as long as the follower 64 is supported by the drive cam 98, the abutment between the follower 64 and the drive cam 98 prevents rotation of the lever 62 about the hinge 63. Consequently, the orientation of the lever 62 about the hinge 63 does not change. However, when the first suspension member 64 is lifted clear off the drive cam 98, for example as a result of an irregularity in the first gum strip G1′ or as a result of contact with one of the spacers 8, 8′, then the lever 62 is free to rotate about the hinge 63 and it will do so as a result of the biasing force exerted by the biasing member 65 onto the lever 62. Consequently, when the first suspension member 6 is lifted in the pick-and-place direction Z independently the drive cam 98, the orientation of the lever 62 is changed.

In this example, the first suspension member 6 is further provided with a displacement sensor 66 that is able to distinguish between controlled displacement, as a result of the first pick-and-place drive 96 displacing said first suspension member 6, and independent displacement of the first suspension member 6. In particular, the displacement sensor 66 is positioned such that it can detect proximity and/or contact with the lever 62 when the lever 62 is in the orientation as shown in FIG. 10, and out of contact or at a distance from the lever 62 when the lever 62 is in the orientation as shown in FIG. 11.

As best seen in FIG. 4, the pick-and-place system 1 further comprises a first spacer 8 and a second spacer 8′ at a first spacing position P1 and a second spacing position P2, respectively, spaced apart in the feeding direction F. The spacers 8, 8′ define a minimum spacing distance D between the gripper plane B and the support plane A when the first gripper head 5 is in the second orientation. In particular, the minimum spacing distance D is the distance between the retaining surface 51 and the support surface 20 when the first gripper head 51 is in the second orientation, resting on the spacers 8, 8′. In this example, the minimum spacing distance D is at least half a millimeter, and preferably at least one millimeter.

In this example, the spacers 8, 8′ are located in the pick-and-place direction Z between the first gripper head 5 and the support 2 when the first gripper head 5 is in a pick-up position above said support 2. In particular, as best seen in FIG. 1, both spacers 8, 8′ extend across the support surface 20 in the first drive direction X, the lateral direction L and/or the bridge direction.

In this example, the spacers 8, 8′ are similar or identical. Hence, the spacers 8, 8′ will be described hereafter with reference to the first spacer 8 only. It will however be appreciated that the following description applies, mutatis mutandis, to the second spacer 8′.

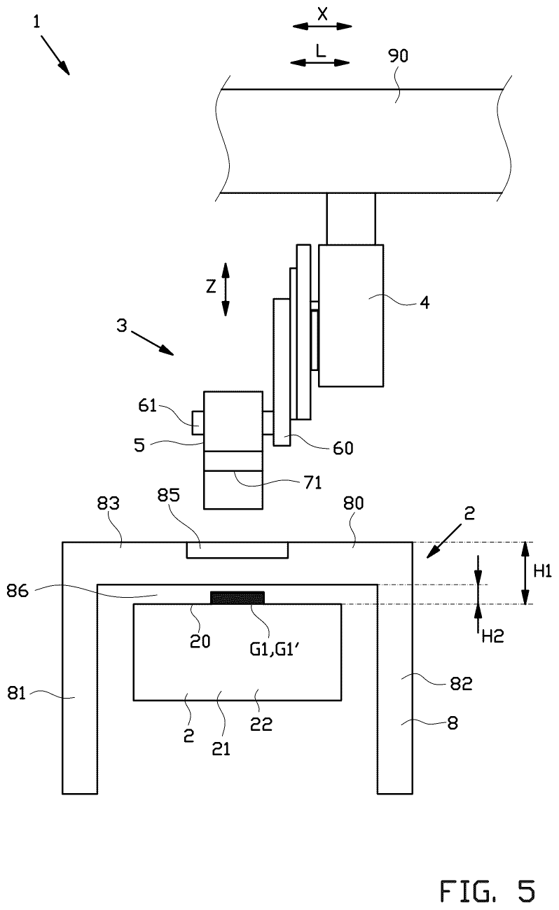

As best seen in FIG. 5, the first spacer 8 comprises a spacer body 80 that is formed by a bridge 83 extending in the first drive direction X, the lateral direction L or the bridge direction between the first gripper head 5 and the support 2 when the first gripper head 5 is in the pick-up position. In this example, the spacer body 80 further comprises a first leg 81 and a second leg 82 on opposite sides of the support 2 for positioning the bridge 83 relative to the support 2.

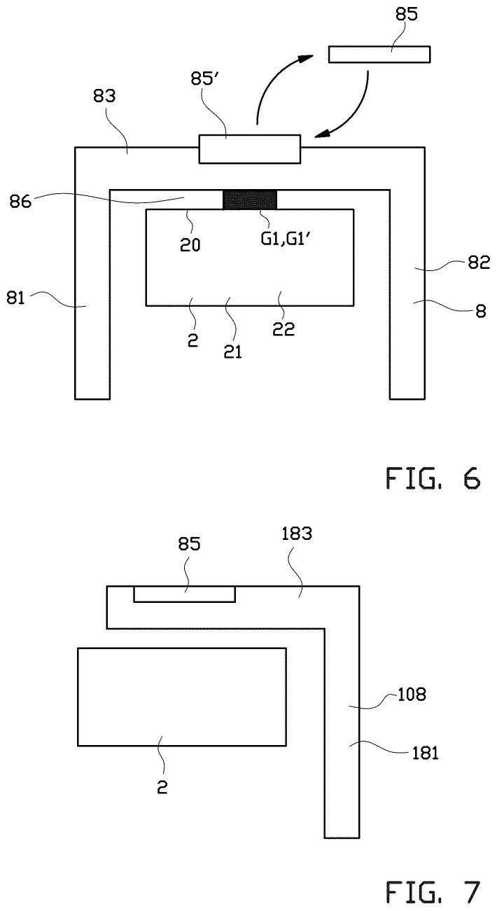

The first spacer 8 forms a resting surface 84 for resting the first gripper head 8 on said first spacer 8 in the pick-and-place direction Z. The resting surface 84 is arranged at a set spacer height H1 above the support plane A. In this example, the first spacer 8 comprises a spacer body 80 and a height adjuster 85 that defines the resting surface 84 relative to the spacer body 80 and sets the spacer height H1. As shown in FIG. 6, the height adjuster 85 may formed as an insert that is detachable and/or removable from the spacer body 80 to be exchanged with an alternative height adjuster 85′ that sets a different spacer height H1. Alternatively, the height adjuster 85 itself may be adjustable in height (not shown), for example by adjusting screws, bolts or the like.

As further shown in FIG. 5, the spacer body 80 extends clear of the support surface A at a gap height H2 to define an infeed gap 86 for the first gum strip G1′ between the support surface 20 and the spacer body 80. As shown in FIG. 1, the first gum strip G1′ can be fed in the feeding direction F underneath or through the infeed gap 86 in said first spacer 8 into a pick-up area in the feeding direction F between the first spacer 8 and the second spacer 8′.

Note that the infeed gap 86 is present at the second spacer 8′ as well, but is strictly not necessary as the first gum strip G1′ usually does not pass the second spacer 8′ in the feeding direction F.

FIG. 7 shows an alternative first spacer 108 that differs from the aforementioned first spacer 8 only in that it has a single leg 181 for supporting the bridge 183 from one side of the support 2 only.

As best seen in FIG. 2, the gripper body 50 of the first gripper head 5 further defines or forms a first abutment surface 71 and a second abutment surface 72 for resting on the first spacer 8 and the second spacer 8′, respectively. In this example, both abutment surfaces 71, 72 are recessed with respect to the retaining surface 51 in a recess direction R parallel to the pick-and-place direction Z, away from the support plane A. Hence, the first gripper head 5 can be supported on the spacers 8, 8′ at a spacer height H1 that is larger than the minimum spacing distance D.

It is noted that, similar to the simplified representation of the pick-and-place gripper 3 in FIGS. 2-4, the first spacer 8 is shown in a simplified manner in FIGS. 5, 6 and 7 as well, as it is shown interacting only with the first gripper head 5 of the simplified pick-and-place gripper 3. However, in case of a dual configuration of the pick-and-place gripper 3, as shown in FIG. 9, the first spacer 8 may have spacer width W in the lateral direction L that is sufficient to span and/or support both the first gripper head 5 and the second gripper head 5′ side-by-side on the same spacer body 80.

A method for picking-up the gum strips G1′, G2′, or any other strip-like tire component G1, G2, using the aforementioned tire manufacturing line 100, and specifically the aforementioned pick-and-place system 1, will now be briefly elucidated with reference to FIGS. 1-19.

FIG. 1 shows the situation in which the gum strips G1′, G2′ are supplied in the feeding direction F onto the support surface 20 of the gum strip supply station 102. The gum strips G1′, G2′ are supported in the support plane A and are ready to be picked-up by the pick-and-place gripper 3. At the other side of the tire manufacturing line 100, the breaker plies K1, K2 are supplied by the breaker supply station 101. One of the breaker plies K1, K2 may optionally be transferred to the gum strip folding station 103.

FIG. 2 shows the situation in which the first gripper head 5 is moved into a pick-up position above and/or overhead the support surface 20.

FIG. 3 shows the situation in which the first gripper head 5 is moved downwards relative to its base 4 by the drive unit 9 towards the support surface 20 in the pick-and-place direction Z until the first abutment surface 71 is in abutting contact with the second spacer 8′. Note that, depending on the misalignment between the pick-and-place gripper 3 and the support 2, the first gripper head 5 may alternatively come into abutting contact with the first spacer 8 first.

FIG. 4 shows the situation in which the first gripper head 5 has been moved further downwards in the pick-and-place direction Z towards the support surface 20. As the first gripper head 5 was already supported on at least one of the spacers 8, 8′, the further movement has caused the first gripper head 5 to tilt about the tilt axis T into the second orientation in which the gripper plane B and the support plane A are aligned and/or parallel. In this second orientation, the gripper plane B of the first gripper head 5 is tilted to a tilt angle E of a few degrees relative to a drive plane spanned by the first drive direction X and the second drive direction Y, or alternatively relative to a horizontal plane.

During said tilting, the spacers 8, 8′ maintain the minimum spacing distance D between the retaining surface 51 of the first gripper head 5 and the support surface 20 of the support 2. Hence, no excessive force is exerted by the first gripper head 5 onto the first gum strip G1′.

Optionally, the minimum spacing distance D may be chosen to be slightly larger than the thickness of the first gum strip G1′. Consequently, the first gripper head 5 initially does not contact the first gum strip G1′ when the first gripper head 5 is at the minimum spacing distance D. It is only when the retaining elements 52, as shown in FIGS. 12 and 13, are supplied with (partial) vacuum, that the first gum strip G1′ is sucked and retained against the retaining surface 51 of the first gripper head 5.

When the first gum strip G1′ is retained to the first gripper head 5, the pick-and-place drives 96, 97 may be controlled to cause the first gripper head 5 to move upwards in the pick-and-place direction Z, away from the support plane A. The first gum strip G1′ can subsequently be transferred by the first gripper head 5 to the breaker supply station 102 and/or the gum strip folding station 103 of FIG. 1, where it may be released from the first gripper head 5.

The steps of the method above may be carried out in the dual configuration of the pick-and-place gripper 3, as shown in FIGS. 1, 8 and 9, for both gripper heads 5, 5′ simultaneously, or for one after the other, thereby picking-up both gum strips G1′, G2′.

Note that, in FIG. 3, the first gripper head 5 is still in the same orientation as in FIG. 2. The pick-and-place system 1 may however already be calibrated during a previous cycle of the method to the tilt angle E required to align the first gripper head 5 with the support 2. The displacement sensors 66, as shown in FIGS. 10 and 11, may be used for this calibration process, as they are able to detect when and/or at which height position the first gripper head 51 contacts one of the spacers 8, 8′ and is lifted independently of the pick-and-place drives 96, 97. Said calibration may be used to already tilt the first gripper head 5, using the pick-and-place drives 96, 97, about the tilt axis T to said predetermined or previously calibrated tilt angle E, prior to the first gripper head 5 contacting any one of the spacers 8, 8′. Hence, the first gripper head 5 can conveniently be placed on both spacers 8, 8′ almost simultaneously without any further tilt that may otherwise cause relative movements between the first gripper head 5 and the support 2 that could potentially damage the first gum strip G1′.

It is to be understood that the above description is included to illustrate the operation of the preferred embodiments and is not meant to limit the scope of the invention. From the above discussion, many variations will be apparent to one skilled in the art that would yet be encompassed by the scope of the present invention.

### LIST OF REFERENCE NUMERALS

1 pick-and-place system
2 support
20 support surface
21 conveyor
22 conveyor belt
3 pick-and-place gripper
4 base
5 first gripper head
50 gripper body
51 retaining surface
52 retaining opening
53 verification opening
54 vacuum chamber
55 verification chamber
56 vacuum channel
57 connection channel
58 vacuum sensor
59 anvil
5′ second gripper head
6 first suspension member
60 carriage
61 first shaft
61′ second shaft
62 lever
63 hinge
64 follower
65 biasing member
66 displacement sensor
6′ second suspension member
71 first abutment surface
72 second abutment surface
8 first spacer
80 spacer body
81 first leg
82 second leg
83 bridge
84 resting surface
85 height adjuster
85′ alternative height adjuster
86 infeed gap
8′ second spacer
9 drive unit
90 drive frame
91 drive rails
92 lateral drive
93 first lateral motor
94 second lateral motor
95 longitudinal drive
96 first pick-up drive
97 second pick-up drive
98 drive cam
99 cam lobe
100 tire manufacturing line
101 breaker supply station
102 gum strip supply station
120 cutting device
121 first cutting table
122 second cutting table
123 third cutting table
124 first cutting slot
125 second cutting slot
126 third cutting slot
127 holder
128 linkages
129 arcuate slot
103 gum strip folding station
108 alternative spacer
181 single leg
183 bridge
190 guide wheels
191 knife
192 cutting table pusher
A support plane
B gripper plane
C cutting plane
D minimum spacing distance
E tilt angle
F feeding direction
G continuous strip
G1 first tire component
G1′ first gum strip
G2 second tire component
G2′ second gum strip
H1 spacer height
H2 gap height
K1, K2 breaker plies
L lateral direction
N correction axis
P1 first spacing position
P2 second spacing position
R recess direction
R1 first rotation axis
R2 second rotation axis
S1 first suspension height
S2 second suspension height
T tilt axis
V vacuum zone
W width
X first drive direction
Y second drive direction
Z pick-and-place direction

1-33. (canceled)

34. A pick-and-place system for picking-up a first tire component, the pick-and-place system comprising:
a support for supporting the first tire component in a support plane; and
a pick-and-place gripper for picking-up the first tire component from the support,
wherein the pick-and-place gripper comprises a base, a first gripper head and a drive unit for moving the first gripper head relative to the base in a pick-and-place direction towards the support plane,
wherein the first gripper head is configured for retaining the first tire component in a gripper plane,
wherein the first gripper head is tiltable about a tilt axis perpendicular to the pick-and-place direction between a first orientation and a second orientation, different from the first orientation,
wherein the gripper plane is parallel to the support plane in one orientation of the first orientation and the second orientation, and
wherein the pick-and-place system further comprises a first spacer for defining a minimum spacing distance between the gripper plane and the support plane when the first gripper head is in said one orientation.

35. The pick-and-place system according to claim 34, wherein the minimum spacing distance is at least half a millimeter.

36. The pick-and-place system according to claim 34, wherein the first gripper head is positionable in a pick-up position in the pick-and-place direction above the support plane for picking-up the first tire component from the support,
wherein the first spacer is located in the pick-and-place direction between the first gripper head and the support when the first gripper head is in the pick-up position.

37. The pick-and-place system according to claim 36, wherein the first spacer comprises a bridge extending in a bridge direction perpendicular to the pick-and-place direction between the first gripper head and the support when the first gripper head is in the pick-up position.

38. The pick-and-place system according to claim 37, wherein the first spacer comprises a first leg for positioning the bridge relative to the support,
wherein the bridge projects from the first leg in the bridge direction over the support.

39. The pick-and-place system according to claim 38, wherein the first spacer comprises a second leg for positioning the bridge relative to the support,
wherein the first leg and the second leg are positioned on opposite sides of the support in the bridge direction.

40. The pick-and-place system according to claim 34, wherein the first spacer forms a resting surface for resting the first gripper head on said first spacer in the pick-and-place direction.

41. The pick-and-place system according to claim 40, wherein the resting surface is arranged at a set spacer height above the support plane.

42. The pick-and-place system according to claim 41, wherein the first spacer comprises a spacer body and a height adjuster that defines the resting surface relative to the spacer body and sets the spacer height.

43. The pick-and-place system according to claim 34, wherein the first spacer comprises a spacer body that extends clear of the support plane at a gap height to define an infeed gap for the first tire component between the support plane and the spacer body.

44. The pick-and-place system according to claim 34, wherein the first spacer defines the minimum spacing distance at a first spacing position,
wherein the pick-and-place system further comprises a second spacer for defining the minimum spacing distance at a second spacing position spaced apart from the first spacing position in a longitudinal direction parallel to the support plane and perpendicular to the tilt axis.

45. The pick-and-place system according to claim 44, wherein the pick-and-place system comprises a conveyor that forms a support surface and that is configured for conveying the first tire component in a feeding direction parallel to the longitudinal direction,
wherein the second spacer is located downstream of the first spacer in the feeding direction.

46. The pick-and-place system according to claim 34, wherein the first gripper head comprises a gripper body that forms a first abutment surface for resting on the first spacer.

47. The pick-and-place system according to claim 46, wherein the gripper body further forms a retaining surface for retaining the first tire component to the gripper body in the gripper plane,
wherein first abutment surface is recessed with respect to the retaining surface in a recess direction parallel to the pick-and-place direction, away from the support plane.

48. The pick-and-place system according to claim 34, wherein the pick-and-place system further comprises a first suspension member and a second suspension member for suspending the first gripper head relative to the base at a first suspension height and a second suspension height, respectively,
wherein the first suspension member is configured for varying the first suspension height relative to the second suspension height.

49. The pick-and-place system according to claim 48, wherein the second suspension member is configured for varying the second suspension height relative to the first suspension height.

50. The pick-and-place system according to claim 49, wherein the drive unit comprises a first pick-and-place drive and a second pick-and-place drive which are operationally connected to the first suspension member and the second suspension member for controlled displacement of said suspension members in the pick-and-place direction.

51. The pick-and-place system according to claim 50, wherein the first gripper head is configured to be displaceable parallel to the pick-and-place direction independently of the first pick-and-place drive and the second pick-and-place drive,
wherein the pick-and-place system is further provided with a displacement sensor at each suspension member for distinguishing between controlled displacement and independent displacement of the respective suspension member.

52. The pick-and-place system according to claim 34, wherein the drive unit is further configured for moving the pick-and-place gripper in a first drive direction orthogonal to the pick-and-place direction and a second drive direction orthogonal to the first drive direction and the pick-and-place direction.

53. The pick-and-place system according to claim 34, wherein the pick-and-place gripper further comprises a second gripper head for retaining a second tire component,
wherein the second gripper head is tiltable in the same way as the first gripper head,
wherein the first spacer is configured for defining the minimum spacing distance also at the second gripper head.

54. The pick-and-place system according to claim 53, wherein the first gripper head and the second gripper head are arranged side-by-side in a lateral direction,
wherein the first spacer extends in said lateral direction over a spacer width that spans both the first gripper head and the second gripper head.

55. The pick-and-place system according to claim 53, wherein the first gripper head and the second gripper head are configured for picking-up strip-like tire components.

56. The pick-and-place system according to claim 34, wherein the first gripper head comprises a gripper body that forms a retaining surface for retaining the first tire component to the gripper body in the gripper plane,
wherein the first gripper head further comprises a plurality of retaining openings for retaining the first tire component to the gripper body through suction and a verification opening for verifying that the first tire component is properly retained to the plurality of retaining openings,
wherein the gripper body forms a vacuum chamber that is arranged in air communication with the plurality of retaining openings and a verification chamber that is arranged in air communication with the verification opening,
wherein the verification chamber is further arranged in air communication with the vacuum chamber through a connection channel, wherein the pick-and-place system further comprises a vacuum sensor for measuring pressure in the verification chamber.

57. The pick-and-place system according to claim 56, wherein the verification opening, in cross section, has a first surface area,
wherein the connection channel, in cross section, has a second surface area equal to or smaller than the first surface area.

58. A tire manufacturing line comprising the pick-and-place system according to claim 34, wherein the tire manufacturing line further comprises a gum strip supply station, a breaker supply station or a gum strip folding station,
wherein the pick-and-place system is configured for transferring one or more gum strips from the gum strip supply station to the breaker supply station or the gum strip folding station.

59. The tire manufacturing line according to claim 58, wherein the gum strip supply station comprises a cutting device for cutting a continuous strip to length to form the gum strips,
wherein the cutting device comprises a cutting table for supporting the continuous strip in a cutting plane and a holder for holding the cutting table,
wherein the cutting table is rotatable about one or more rotation axes parallel to the cutting plane.

60. The tire manufacturing line according to claim 59, wherein the one or more rotation axes comprises a first rotation axis and a second rotation axis orthogonal to the first rotation axis.

61. The tire manufacturing line according to claim 59, wherein at least one rotation axis of the one or more rotation axes coincides with the cutting plane.

62. The tire manufacturing line according to claim 59, wherein the first gripper head comprises an anvil that cooperates with the cutting table to hold the continuous strip for cutting,
wherein the cutting table is freely rotatable about the one or more rotation axes to adapt its orientation to the anvil.

63. A method for picking-up a first tire component using the pick-and-place system according to claim 34, wherein the method comprises the steps of:
supporting the first tire component in the support plane;
moving the first gripper head relative to the base in the pick-and-place direction towards the support plane;
causing a tilt of the first gripper head about the tilt axis into said one orientation in which the gripper plane is parallel to the support plane; and
using the first spacer to maintain the minimum spacing distance between the gripper plane and the support plane when the first gripper head is in said one orientation.

64. The method according to claim 63, wherein the minimum spacing distance is chosen such that the first gripper head does not contact the first tire component initially when the first gripper head is at the minimum spacing distance in said one orientation.

65. The method according to claim 63, wherein the first gripper head is tilted about the tilt axis as a result of contact of said first gripper head with the first spacer.

66. The method according to claim 63, wherein the first gripper head is tilted about the tilt axis by the drive unit to a previously configured tilt angle corresponding to said one orientation prior to contact between the first gripper head and the first spacer.
